(19) United States
(12) Patent Application Publication
(10) Pub. No.: US 2006/0204048 A1
(43) Pub. Date: Sep. 14, 2006

(54) Systems and methods for biometric authentication

(76) Inventors: Robert A. Morrison, Sedalia, CO (US); Ronald N. Baird, Sedalia, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/089,605

(22) Filed: Mar. 25, 2005

Related U.S. Application Data
(60) Provisional application No. 60/657,375, filed on Mar. 1, 2005.

(51) Int. Cl. G06K 9/00

(52) U.S. Cl. 382/115; 902/3

(57) ABSTRACT

In one embodiment, an authentication system includes: a sensor for sensing a biometric and for providing a first code in response to sensing the biometric; and a processor for evaluating the first code to authenticate a user of the sensor independent of said sensor sensing the biometric. The biometric may be one or more of a group consisting of: retinal information; fingerprint information; ocular information; DNA; veinal information; arterial information; voice information; and pulmonary information. The processor may include a code generator to generate a second code for evaluating the first code. The processor may also include a comparator for comparing the first code and the second code to authenticate the user.

### CROSS REFERENCE TO RELATED APPLICATIONS

This patent application claims priority to and thus the benefit of an earlier filing date from U.S. Provisional Patent Application No. 60/657,375 (filed Mar. 1, 2005), the entire contents of which are hereby incorporated by reference.

### BACKGROUND OF THE INVENTION

1. Field of the Invention

The invention generally relates to biometric authentication. More specifically, the invention relates to authentication of the identity of a user whose biometric information is not stored with a central processing system.

2. Discussion of the Related Art

Authentication of a person is often desirable and in many cases necessary. For example, to prevent unauthorized access to a user's financial account (e.g., via a credit card, a debit card, etc.), the financial institution maintaining the account typically requires information pertaining to the user's account (e.g., a credit card number) during a transaction. A central processing system may then authorize the transaction based on a verification of the user's information.

To improve authentication of a user, biometric authentication systems have been developed which authenticate the user's identity based on input biometric information, such as a fingerprint scan and/or a retinal scan. In such authentication systems, the user may input biometric information to the system and the system may subsequently compare that input information to the user's biometric information stored with the system. Although an effective means for authenticating the user, the present biometric authentication systems can expose the user's unique biometric information to a multitude of people and/or computer systems. The availability of such uniquely personal information erodes privacy that is cherished by members of a free society. Additionally, the increased exposure of this uniquely personal information increases the likelihood of identity theft.

### SUMMARY OF THE INVENTION

In one embodiment of the invention, an authentication system includes: a sensor for sensing a biometric and for providing a first code in response to sensing the biometric; and a processor for evaluating the first code to authenticate the identity of a user of the sensor independent of said sensor sensing the biometric. The biometric may be one or more of a group consisting of: retinal information; fingerprint information; ocular information; DNA; veinal information; arterial information; voice information; and pulmonary information. The processor may include a code generator to generate a second code for evaluating the first code. The processor may also include a comparator for comparing the first code and the second code to authenticate the user.

The sensor may include a code generator synchronizable with the code generator of the processor. The code generator of the processor may be a random number generator.

The processor may include an Internet access link configured for allowing a user to establish an account with the authentication system. The account is preferably devoid of a user's biometric. The Internet access link may include an Internet server configured for maintaining software used to establish the account. The Internet access link may further include a database configured for storing a plurality of accounts.

In one embodiment, the authentication system also includes an input unit for receiving the first code and for granting access based on the first code. The input unit may be configured with the processor. However, the input unit may be configured independent of the processor. The authentication may also include a communication link between the processor and the input unit for transferring an access indicator from the processor to the input unit. The communication link may be configurable with one or more of a group consisting of: a wide area network; a local area network; a wireless network; a public switching telephone network; and the Internet. The access is to a financial account, a medical account, an entry, a computer, a means of transportation, or government information.

In another embodiment of the invention, a method of authentication includes: using a biometric to generate a first code; and authenticating a user based on the first code and independent of said step of using. The step of using a biometric may include a step of comparing the biometric with stored biometric information.

The method may also include a step of generating the first code with a device used to store the biometric information. The step of generating the first code may include a step of generating a random number based on a comparison of the biometric and the stored biometric information. The stored biometric information may be one or more of a group consisting of: retinal information; fingerprint information; ocular information; DNA; veinal information; arterial information; voice information; and pulmonary information. The device may be a portable device.

The step of authenticating a user may include a step of generating a second code. The method may also include a step of granting a user access based on a comparison of the first code and the second code. Additionally, the method may include a step of entering the first code with an input device. The steps of entering the first code and generating a second code may be colocated steps.

The step of granting a user access may include a step of generating an access indicator for the input device. The step of granting a user access may further include a step of transferring the access indicator to an access point where the user is located. The step of transferring the access indicator may include a step of conveying the access indicator through a network, wherein the network is one or more of a group consisting of: wide area network; a local area network; a wireless network; a public switching telephone network; and the Internet. The method may also include a step of transferring the first code from the input device to a processor for comparison of the first code and the second code.

In one embodiment of the invention,

### BRIEF DESCRIPTION OF THE DRAWINGS

FIG. 1 is a block diagram of a biometric authentication system, in one exemplary embodiment of the invention.

FIG. 2 is an illustration of a biometric device, in one exemplary embodiment of the invention.

FIG. 3 is a block diagram of a processor operable with an authentication device, in one exemplary embodiment of the invention.

FIG. 4 is a flowchart illustrating one exemplary methodical embodiment of a biometric authentication system.

FIG. 5 is a flowchart illustrating one exemplary process of the methodical embodiment of FIG. 4.

FIG. 6 is a flowchart illustrating another exemplary process of the methodical embodiment of FIG. 4.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

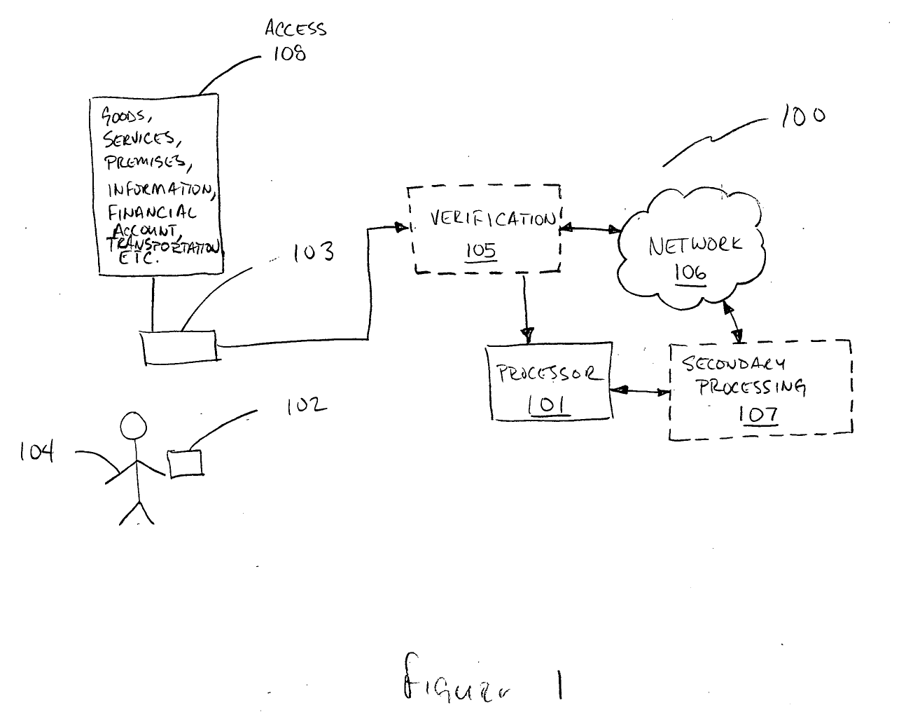

FIG. 1 is a block diagram of a biometric authentication system 100, in one exemplary embodiment of the invention. In this embodiment, system 100 authenticates a user's biometric to grant user 104 access 108 to, for example, goods, services, premises information, a financial account, transportation, a computer, a network, a website, a database, a cell phone, etc. Biometric information of the user 104 is stored with a device 102 personal to the user. For example, device 102 may be a fingerprint scanning device that the user 104 keeps in his possession. Such a device 102 may have user 104's fingerprint information stored therein. User 104 may use the device 102 to scan user 104's fingerprint. Device 102 may compare the inputted fingerprint information of user 104 to the stored fingerprint information and generate a code upon valid comparison of the inputted fingerprint information to the stored fingerprint information. User 102 may use the generated code as an input to authentication device 103 for processor 101 to authenticate. Although user 104's biometric information is stored with device 102, that biometric information is not stored elsewhere within system 100.

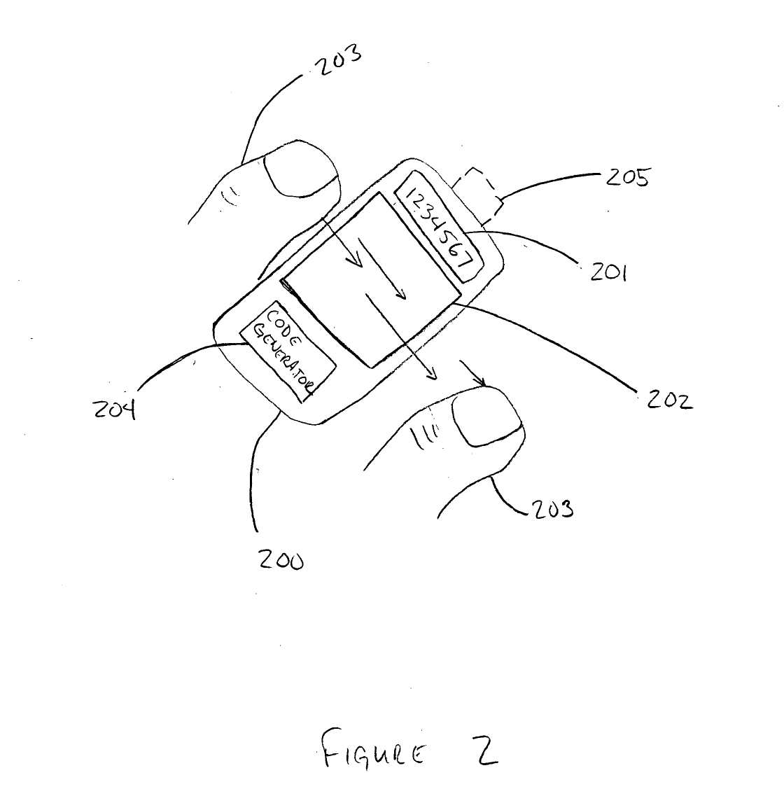

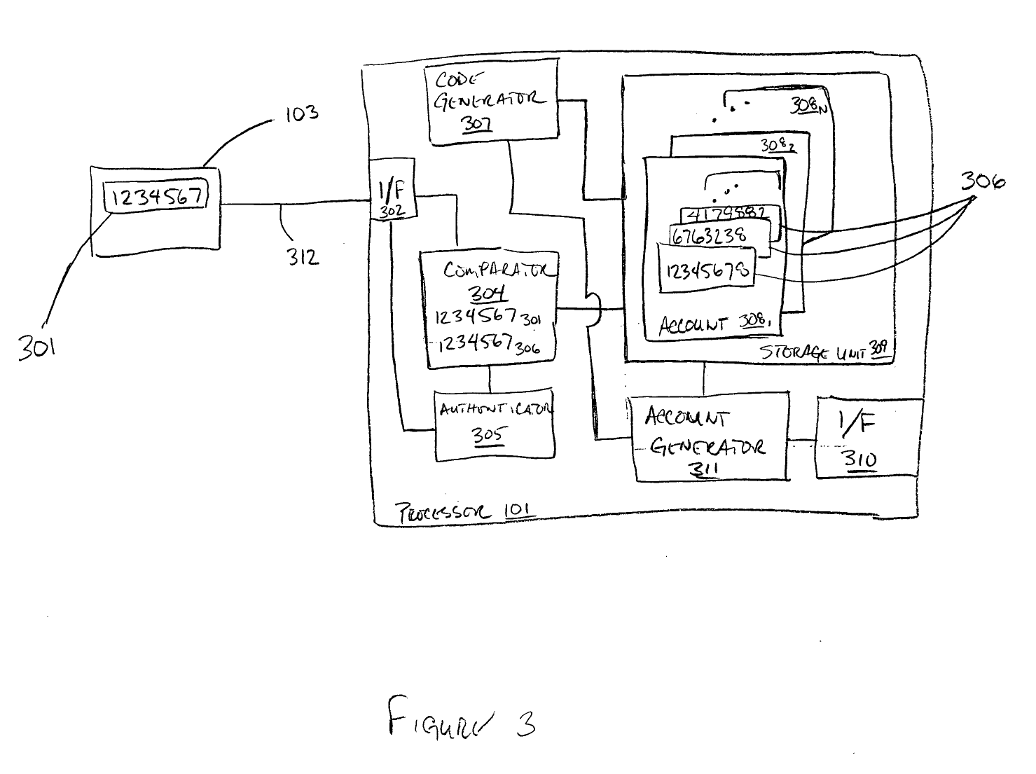

The code generated by device 102 may be synchronous with a code of processor 101. For example, processor 101 may include a code generator, such as a random number generator, which generates codes associated with user 104's account. In one embodiment, the code is a random number that optionally includes at least part of an encoded version of the serial number of device 102. Similarly, device 102 may include a code generator that is algorithmically synchronized to the code generator of processor 101. When user 104 inputs a generated code into authentication device 103, authentication device 103 may transfer that code to processor 101 for comparison to a code generated by processor 101. Upon a valid comparison of the two codes, processor 101 may transfer an access indicator to authentication device 103 to grant access 108 to user 104. Examples of code generators are illustrated and described below in FIGS. 2 and 3.

Algorithmic synchronization of the two code generators (i.e., of device 102 and processor 101) as used herein implies that processor 101 has no continuous communication to device 102. For example, processor 101 has no access to biometric information stored with device 102. Rather, device 102 may be used for one-way communication (e.g., a simplex communication) to user 104 and/or to authentication device 103. Algorithmic synchronization, therefore, refers to the process in which codes are similarly generated between device 102 and processor 101.

In one embodiment, processor 101 generates and stores a predetermined number of codes. When device 102 becomes out of sync with a “next in line” code of processor 101, user 104 may be required to reenter a biometric (e.g., rescan user 104's fingerprint) and generate a new code for input to authentication device 103. For example, user 104 may use device 102 to scan a fingerprint and generate a code. If user 104 does not use that freshly generated code, that code may expire and codes of processor 101 may become out of sync with subsequent codes of device 102. Once out of sync, user 104 may be required to rescan a fingerprint for a predetermined number of times to generate a corresponding sequence of codes. The sequenced input of these codes to authentication device 103 may correspond to a sequence of codes stored with processor 101. Processor 101 may, therefore, algorithmically search for the input sequence of codes from the stored sequence of codes and generate an access indicator based on the correctly input sequence. Processor 101 may then transfer this access indicator to authentication device 103 to grant access 108 to user 104.

In one embodiment, system 100 includes one or more secondary processing elements 107 for processing portions of a code input by user 104 to authentication device 103. For example, the code processing of processor 101 described hereinabove may be performed off processor 101 by secondary processing element 107. In such an embodiment, a code input by user 104 to authentication device 103 may be compared entirely to a synchronized code of secondary processing element 107. However, security of such code processing may be enhanced via processing by a plurality of secondary processing elements 107 wherein each secondary processing element 107 processes a portion of a code entered by user 104. Such separable code processing by a plurality of secondary processing elements 107 may enhance security of system 100 because attempts to retrieve an entire code from system 100 (e.g., hacking and/or other security attacks) are inhibited.

Additionally, system 100 may be configured with a verification element 105 which further enhances security. For example, verification element 105 may receive an access indicator from processor 101 once the code has been successfully input to authentication device 103 by user 104. Verification element 105 may then require additional information from user 104, such as a password or account information (e.g., via the swiping of a magnetic strip on a credit card). The increased number of security features may lessen the probability of an unauthorized access by biometric authentication system 100.

In one embodiment, a Lock Adminstrator is responsible for distributing devices to users. The Lock Administrator, for example, might be an individual who is responsible for distributing a plurality of devices 102 to company employees. In this regard, the Lock Administrator would be able to delete a user and/or enroll a new user via processor 101. The Lock Adminstrator, however, would not be able to delete himself from biometric authentication system 100. To ensure integrity of biometric authentication system 100 in the event that Lock Administrator is removed from his position at the company, devices 102 may be disposed of or reconfigured for other users.

Biometric authentication system 100 may be configured in a variety of ways to implement the principles described herein. For example, processor 101 may be a general-purpose computer or server subsystem hosting software configured to receive and process a code to grant access 108 to user 104. Secondary processing element 107 and verification element 105 may be similarly configured as general-purpose computers or server subsystems to perform as described herein. Authentication device 103 may be any well-known device for authenticating a user that is configured for receiving an input code from the user. The manner in which authentication device 103 may be configured to receive such an input is typically a matter of design choice. For example, authentication device 103 may be configured with a key pad, an infrared receiver, a Radio Frequency (“RF”) receiver, etc. that receives a code from user 104 as appropriate. For at least these reasons, those skilled in the art should readily recognize that the invention should not be limited to any particular configuration used to implement the principles described herein.

FIG. 2 is an illustration of a biometric device 200, in one exemplary embodiment of the invention. In this embodiment, biometric device 200 is configured for scanning a fingerprint 203 of a user (e.g., user 104 of FIG. 1) and authenticating the scanned fingerprint. For example, biometric device may include a sensor 202 used to sense the user's fingerprint 203 being depressed against sensor 202 and/or “swiped” across sensor 202. Sensor 202 may subsequently convert the sensed fingerprint to electronic data representative of the sensed fingerprint and compare that electronic data to fingerprint information of the user stored within biometric device 200. Biometric device 200 may then generate an authentication code via code generator 204 and display that code to the user via display unit 201. This authentication code is not continuously maintained with biometric device 200. For example, after a pre-determined period of time and/or a swipe of the finger, the authentication code may be deleted from memory of biometric device 200.

Those skilled in the art understand fingerprint sensing and the electronic data conversion thereof. Implementations of such fingerprint sensing are often a matter of design choice. Additionally, those skilled in the art should readily recognize that biometric device 200 may be configured to sense other biometrics, such as retinal information, corneal information, pulse information, DNA, ocular information, etc. Those skilled in the art are familiar with the various implementations for such other biometrics. Accordingly, the invention should not be limited to the exemplary embodiment of fingerprint sensing described and illustrated herein.

Biometric device 200 may also be configured with an output communication port 205 for conveying a generated code to an authentication device, such as authentication device 103 of FIG. 1. For example, output communication port 205 may be a serial port, an infrared port, an RF port, etc., each of which configurable for conveying a code generated by biometric device 200 to the authentication device. In such an embodiment, display unit 201 may be an alternative feature of biometric device 200 because generated code information may no longer be useful to the user.

In one embodiment, a Lock Administrator may issue biometric device 200 to the user. When device 200 is issued to user 104, the user may be able to establish code synchronization without the assistance of a Lock Adminstrator. In such an embodiment, user 104 may, for example, initiate and or resync the device 200 by pressing and holding a button and/or “swiping” a finger several one or more times across sensor 202. However, user 104 may not delete himself after enrollment. Such disenrollment may be reserved for the Lock Adminstrator.

Once enrollment is successfully completed, the device may generate, for example, a 16 character alphanumeric registration code, which may be based on a random number, a serial number, and/or a sectorization of the user's fingerprint. This generated number may be stored in non-volatile memory (e.g., non-volatile random access memory; “NVRAM”). This code may be overwritten if the Lock Administrator disenrolls the user so that a new user may be enrolled. In this instance, a new registration code is created and stored on the device. The 16-character registration code will be displayed on the LCD immediately after a successful enrollment.

In one embodiment, display unit 201 is a liquid crystal display (“LCD”) that displays 8 characters of the 16 character alphanumeric registration code. Accordingly, biometric device 200 via display unit 201 will display the first 8 characters and, e.g. after the push of a button, the next 8 characters. The button depression may be used to toggle between the first set of 8 characters and the second set of 8 characters. However, those skilled in the art should readily recognize that display unit 201 may be configured to display all 16 characters, for example, via two rows of 8 characters on the LCD. Additionally, the user may be able to retrieve this 16-character registration code at a later time following, for example, an authorized finger swipe and series of button pushes. In one embodiment, the registration code is communicated to the Lock Administrator who then enters it into a database of processor 101 of FIG. 1 to manage access privileges of biometric device users.

Those skilled in the art are readily familiar with configuring a device, such as biometric device 200, with an LCD and buttons to control the LCD. For example, biometric device 200 may be configured as an embedded device controlled by a microprocessor and embedded software to control such features of the device. Those skilled in the art are readily familiar with embedded systems and software.

FIG. 3 is a block diagram of processor 101 of FIG. 1 operable with authentication device 103, in one exemplary embodiment of the invention. In this embodiment, processor 101 is configured for receiving a code 301 from authentication device 103 as input by a user (e.g., user 104 of FIG. 1) and for processing the code 301 to generate an authentication indicator upon verification of a successful code entry. Processor 101 may, upon verification, generate an authentication indicator for authentication device 103 to grant access to the user.

In this embodiment, processor 101 is communicatively coupled to authentication device 103 via a communication link 312. Processor 101 may include an interface 302 for transferring information between authentication device 103 and processor 101 via communication link 312. For example, processor 101 may receive codes from authentication device 103 for processing. Processor 101 may also transmit authentication indicators to authentication device 103. The communication link 312 between processor 101 and authentication device 103 may be used to implement this communication. In this regard, communication link 312 may be configured in a variety of manners that are often a matter of design choice. For example, communication link 312 may be an Internet connection, a wire line connection (e.g., Universal Serial Bus, or “USB”; Institute for Electrical and Electronics Engineers standard 1394, or “FireWire”; American National Standards Institute twisted pair categories 1-6, or “ANSI Cat” 1-6; etc.), an infrared connection, and/or an RF connection. Those skilled in the art are readily familiar with establishing such communication links between devices.

Processor 101 may include a comparator 304 communicatively coupled to interface 302 for receiving code 301 from authentication device 103. Comparator 304 may be configured for comparing for comparing code 301 to a code 306 generated by processor 101. Upon a valid comparison of codes 301 and 306, comparator 304 may indicate to authenticator 305 that a user may be granted access. Authenticator 305 may thereby generate an authentication indicator and transfer that authentication indicator to interface 302 for subsequent use by authentication device 103. For example, authentication device 103 may use the authentication indicator to grant access to the user.

Codes 301 and 306 may be generated from synchronized code generators. For example, processor 101 may include a code generator 307 configured for generating codes 306 for a particular user account 308. A biometric device, such as biometric device 200 of FIG. 2, may include a code generator that generates code 301 upon verification of a biometric input with the biometric device. Code generator 307 may be configured in a manner similar to that of the biometric device wherein the two code generators are synchronized to each other when an authentication account is created for the user (discussed herein below). Once synchronized, the code generator 307 and the code generator of the biometric device may generate the same codes although the two code generators are independent of one another.

The code generator 307 and the code generator the biometric device may “desynchronize” over a period of time. For example, when a user scans a fingerprint across a sensor of the biometric device and the biometric device subsequently verifies the fingerprint, the biometric device generates a code 301. If that code is not used by the user (e.g., input to authentication device 103), the code generated by the biometric device may expire and the two code generators become unsynchronized.

To counter such desynchronization effects, code generator 307 may generate a plurality of codes 306. Since the code generator 307 and the code generator of the biometric device are similarly configured to generate the same code sequence, the two code generators may be resynchronized by having the user reenter a biometric to generate a new code for input to authentication device 103. Alternatively, processor 101 may require the user to reenter a biometric, generate a new code and enter the new code into input device a predetermined number of times (i.e., input a sequence of codes with authentication device 103). Once a new code or a sequence of new codes has been correctly entered with authentication device 103 and authenticated by processor 101, the code generator 307 resynchronizes with the code generator of the biometric device because code generator 307 will be aware of the next number generated by the biometric device. Accordingly, the codes generated by the biometric device and code generators 307 may be once again be synchronized for subsequent identity authentication. In one embodiment of the invention, the code generator 307 and the code generator of the biometric device are random number generators configured for generating random codes. Such codes may be alphanumeric in nature and contain various randomization techniques, such as those found in well-known 32-bit, 64-bit and 128 bit encryption techniques.

In one embodiment of the invention, processor 101 has an account generator 311. The account generator 311 is communicatively coupled to interface 310 for establishing an account for a biometric user. For example, account generator 311 may generate an account 308 for a new biometric device user based on an organization's need for biometric authentication. The user may establish the account with account generator 311 by inputting certain information, such as name, birthday, address, phone number, social security number, etc., via interface 310. Interface 310 may be substantially any type of communication interface (e.g., a graphical user interface, or “GUI”) that enables the user to communicate such information to account generator 311. Account generator 311 may then generate an account 308 for the user based on the user's entered information.

Once an account 308 is established, account generator may transfer a code synchronization “seed” to the user for entrance into the user's biometric device. For example, the code generator of the biometric device may generate random codes; however, randomization of the codes may begin from a certain predetermined number. Account generator 311 may generate that predetermined number as a seed from which the code generator of the biometric device is to begin random code generation. To synchronize code generator 307 with the code generator of the biometric device, account generator 311 may similarly seed code generator 307.

Account generator 311 may be used to generate a plurality of accounts 308; for example, account generator 311 may generate one account for each registered biometric device. Code generator 307 may be used to generate a plurality of codes 306 (i.e., a code sequence) for each account 308. The accounts 308 and their associated authentication codes 306 may be stored in a storage unit 309 of processor 101. For example, processor 101 may be a general-purpose computer and/or a server subsystem having an account database configured within a hard disk drive thereof for storing and maintaining accounts 308.

Components of processor 101 may be configured in a variety of ways that fall within the scope and spirit of the invention. For example, as previously stated, processor 101 may be a general-purpose processor and/or a server subsystem. Accordingly, the components (e.g., code generator 307, comparator 304, authenticator 305, account generator 311, interfaces 302 and 310 and storage unit 309) of processor 101 may be configured from hardware, software, firmware or various combinations thereof. Those skilled in the art are readily familiar with hardware, software, firmware and their various combinations.

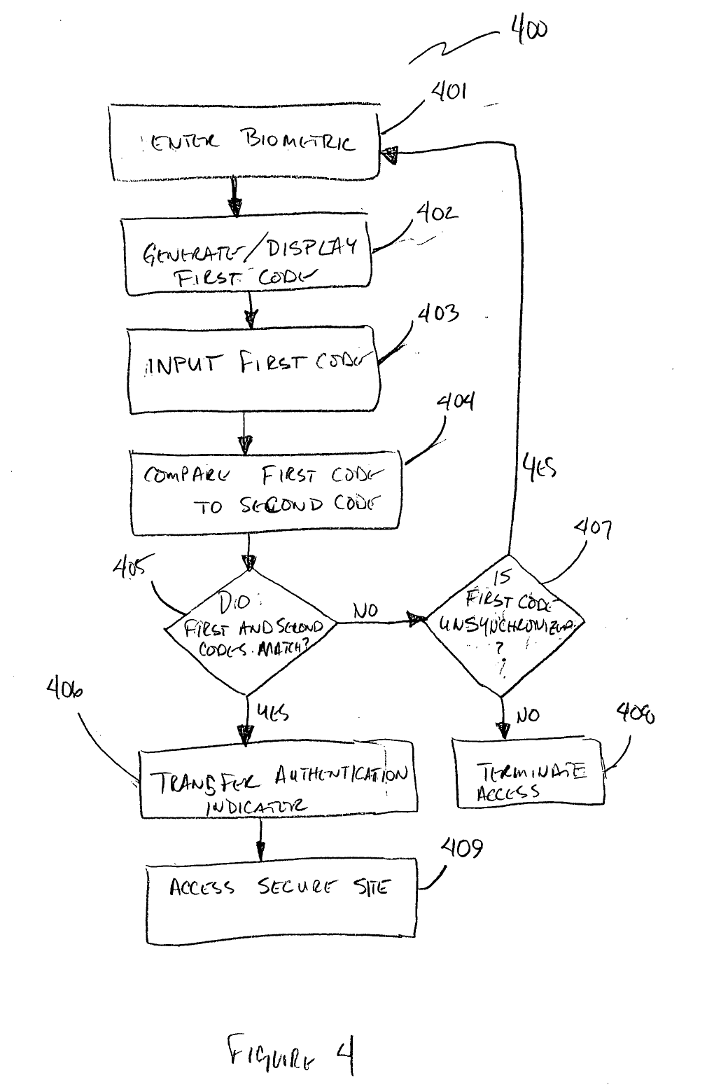

FIG. 4 is a flowchart 400 illustrating one exemplary methodical embodiment of a biometric authentication system, such as biometric system 100 of FIG. 1. In this embodiment, a user initiates biometric authentication by entering a biometric into a biometric device, such as biometric device 200 of FIG. 2, in element 401. The biometric device subsequently generates a first code which is optionally displayed with the biometric device, in element 402. For example, upon entering a valid biometric, the biometric device may generate a code for the user to input to an authentication device, such as authentication device 103 of FIG. 1. The biometric device may display this code upon a display unit of the device such that the user may read the code and input the code to the authentication device. Alternatively, the biometric device may communicate the code directly to the authentication device (e.g., via infrared, RF, etc.). The code is thereby input to the authentication device, in element 403.

Once the code is input to the authentication device, the code is processed to verify that the code is valid. For example, a processor, such as processor 101 of FIG. 1, may generate a second code for comparison to the code generated by the biometric device (i.e., the first code), in element 404. Once the two codes are compared, processing is performed to determine whether the first and second codes match, in decision block 405. If the first and second codes match, then an authentication indicator is transferred to an authentication device where, for example, the user is located, in element 406. The authentication indicator is used to grant the user access to a secure site, in element 409. Examples of a secure site may include a secure entrance, financial account information, transportation, premises, goods, services, etc.

If the first and second codes do not match in decision block 405, a second decision may be made to determine whether the first code is unsynchronized with the second code, in element 407. For example, a user may enter a biometric into the user's personal biometric device to generate a code. If a code is not used, subsequent codes by the biometric device may be unsynchronized with respect to the second code. Decision block 407 may therefore determine if an entered code is within a certain sequence of codes maintained by the processor. If a determination is made that the first code and the second code are merely unsynchronized, processing of the method 400 may return to element 401 to have the user reenter a biometric into the user's personal biometric device. Method 400 may therefore continue processing as previously described. If, however, a determination is made in decision block 407 that the first and second codes are not unsynchronized, access is denied and the method terminates, in element 408.

Those skilled in the art should readily recognize that the features of method 400 are exemplary in nature and are not intended to limit the invention to a particular embodiment. Additionally, those skilled in the art should readily recognize that the features of method 400 may be implemented in a variety of manners. Certain features of method 400 may be implemented in hardware, software, firmware or various combinations thereof to implement the concepts herein. For example, a biometric device may comprise a hardware sensor, a processor and firmware components to sense a user's biometric and generate the first code. Accordingly, those skilled in the art should readily recognize that the invention is not intended be limited to the exemplary embodiment described herein.

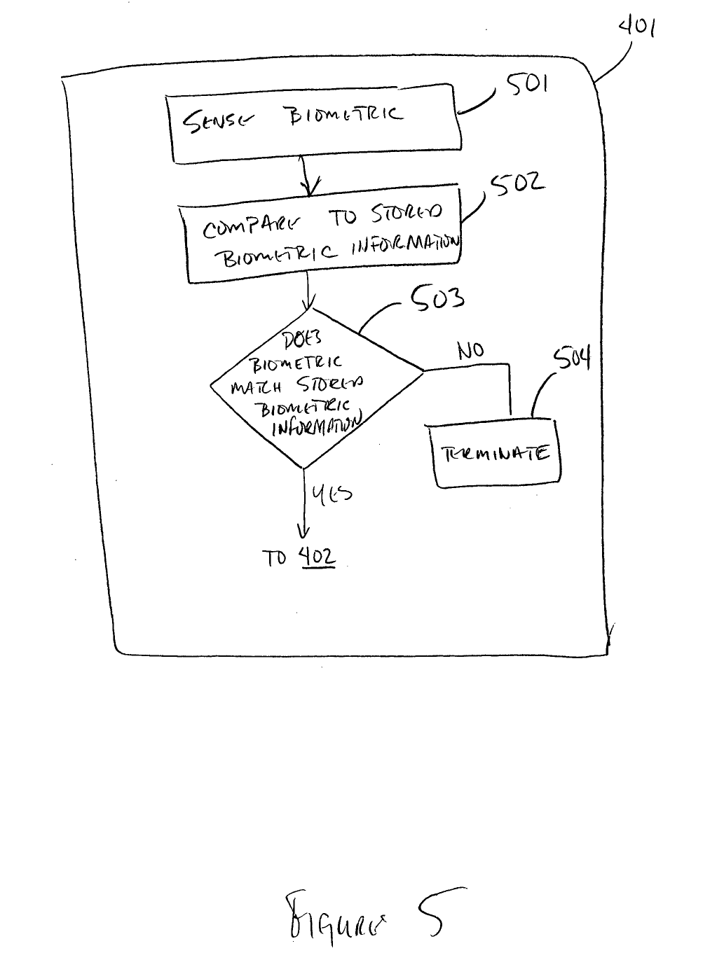

FIG. 5 is a flowchart illustrating one exemplary process 401 of the methodical embodiment 400 of FIG. 4. For example, entering a biometric into a biometric device may include sensing the biometric with a sensor, in element 501. Examples of such biometric sensing may include retinal scans, corneal scans, fingerprint scans, DNA sensing, ocular sensing, pulse sensing, etc. Once the biometric is sensed, the biometric may be converted to electronic information for comparison to stored biometric information within the device, in element 502. A decision is made in decision block 503 to determine whether the entered biometric matches the stored biometric information of the device. If the entered biometric does match the stored information of the biometric device, the process 401 may proceed to element 402 of method 400. If the entered biometric does not match the stored information of the biometric device, process 401 may be terminated, in element 504, as a security feature to prevent code generation for an unintended user.

Security may be enhanced in element 504 by configuring determination process with certain optional features. For example, if the biometric device has an invalid biometric entered a certain number of times, element 504 may be configured to block out the biometric device from future biometric entries.

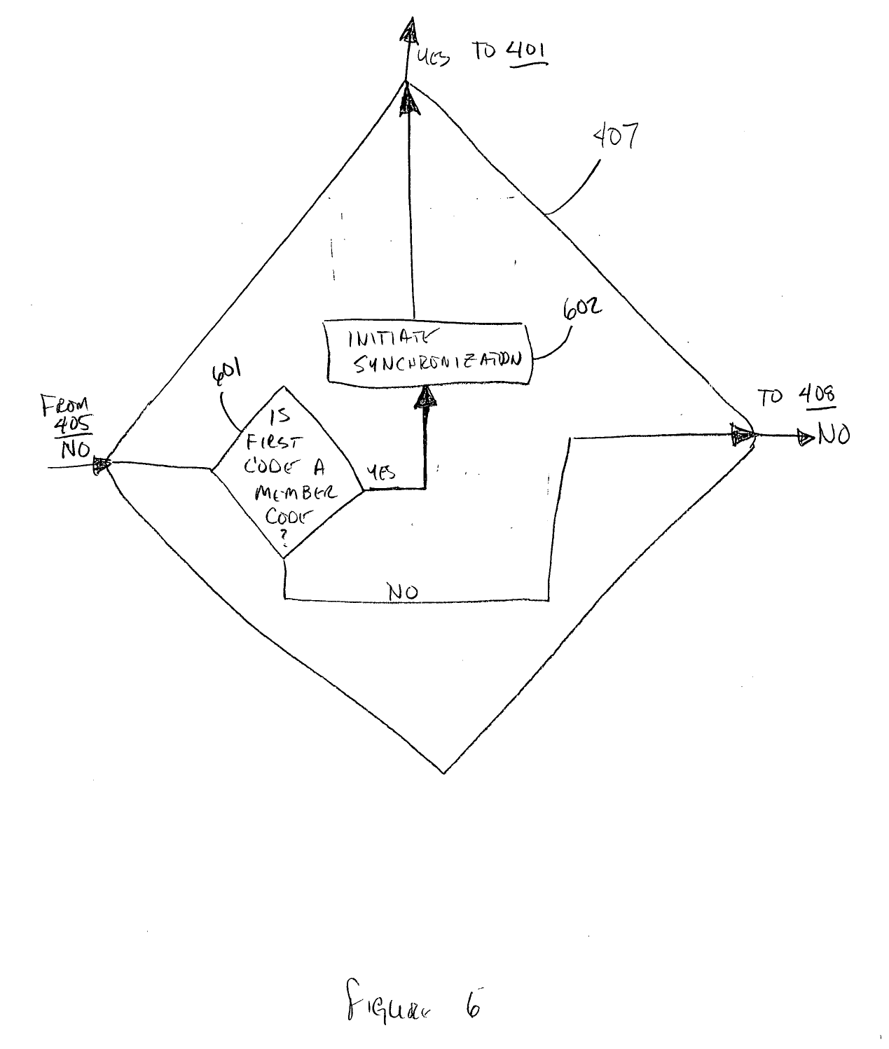

FIG. 6 is a flowchart illustrating exemplary process 407 of the methodical embodiment 400 of FIG. 4. For example, upon an indication that the first and second codes do not match in decision block 405, decision block 407 may determine if the first code is a “member code” of a sequence of codes generated by a processor, such as processor 101 of FIG. 1. The sequence of codes may be generated by a code generator of the processor that is synchronized to a code generator of a user's personal biometric device. The code generator of the processor may generate a sequence of codes in anticipation of codes generated by the biometric device. Accordingly, when a first code is generated by the biometric device that does not match, a determination may be made in element 601 as to whether the first code is one of the sequence of codes generated by the processor.

If the first code is a member code, the processor may initiate synchronization of the two code generators, namely the code generator of the processor and the code generator of the biometric device, in element 602. This synchronization may be performed as described in FIG. 4. For example, the decision block 407 may return to element 401 of FIG. 4. If, however, the first code is not a member of the codes generated by the code generator of the processor, decision block 407 proceeds to terminate via element 408 of FIG. 4.

While the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

1. An authentication system, including:
a sensor for sensing a biometric and for providing a first code in response to sensing the biometric; and
a processor for evaluating the first code to authenticate a user of the sensor independent of said sensor sensing the biometric.

2. The authentication system of claim 1, wherein the biometric is one or more of a group consisting of: retinal information; fingerprint information; ocular information; DNA; veinal information; arterial information; voice information; and pulmonary information.

3. The authentication system of claim 1, wherein the processor includes a code generator to generate a second code for evaluating the first code.

4. The authentication system of claim 3, wherein the processor further includes a comparator for comparing the first code and the second code to authenticate the user.

5. The authentication system of claim 3, wherein the sensor includes a code generator synchronizable with the code generator of the processor.

6. The authentication system of claim 3, wherein the code generator of the processor is a random number generator.

7. The authentication system of claim 1, wherein the processor includes an Internet access link configured for allowing a user to establish an account with the authentication system.

8. The authentication system of claim 6, wherein the account is devoid of a user's biometric.

9. The authentication system of claim 6, wherein the Internet access link includes an Internet server configured for maintaining software used to establish the account.

10. The authentication system of claim 9, wherein the Internet access link further includes a database configured for storing a plurality of accounts.

11. The authentication system of claim 1, further including an input unit for receiving the first code and for granting access based on the first code.

12. The authentication system of claim 11, wherein the input unit is configured with the processor.

13. The authentication system of claim 11, wherein the input unit is configured independent of the processor.

14. The authentication system of claim 13, further including a communication link between the processor and the input unit for transferring an access indicator from the processor to the input unit.

15. The authentication system of claim 14, wherein the communication link is configurable with one or more of a group consisting of: a wide area network; a local area network; a wireless network; a public switching telephone network; and the Internet.

16. The authentication system of claim 11, wherein the access is to a financial account, a medical account, an entry, a computer, a means of transportation, or government information.

17. A method of authentication, including steps of:
using a biometric to generate a first code; and
authenticating a user based on the first code and independent of said step of using.

18. The method of claim 17, wherein the step of using a biometric includes a step of comparing the biometric with stored biometric information.

19. The method of claim 18, further including a step of generating the first code with a device used to store the biometric information.

20. The method of claim 19, wherein the step of generating the first code includes a step of generating a random number based on a comparison of the biometric and the stored biometric information.

21. The method of claim 18, wherein the stored biometric information is one or more of a group consisting of: retinal information; fingerprint information; ocular information; DNA; veinal information; arterial information; voice information; and pulmonary information.

22. The method of claim 18, wherein the device is a portable device.

23. The method of claim 17, wherein said step of authenticating a user includes a step of generating a second code.

24. The method of claim 23, further including a step of granting a user access based on a comparison of the first code and the second code.

25. The method of claim 23, further including a step of entering the first code with an input device.

26. The method of claim 24, wherein the steps of entering the first code and generating a second code are colocated steps.

27. The method of claim 24, wherein the step of granting a user access includes a step of generating an access indicator for the input device.

28. The method of claim 28, wherein the step of granting a user access further includes a step of transferring the access indicator to an access point where the user is located.

29. The method of claim 27, wherein the step of transferring the access indicator includes a step of conveying the access indicator through a network, wherein the network is one or more of a group consisting of: wide area network; a local area network; a wireless network; a public switching telephone network; and the Internet.

30. The method of claim 25, further including a step of transferring the first code from the input device to a processor for comparison of the first code and the second code.

31. A system of authentication, including:
means for using a biometric to generate a first code; and
means for authenticating a user based on the first code and independent of said means for using.

32. The system of claim 31, wherein the means for using a biometric includes means for comparing the biometric with stored biometric information.

33. The system of claim 32, further including means for generating the first code with a device used to store the biometric information.

34. The system of claim 33, wherein the means for generating the first code includes means for generating a random number based on a comparison of the biometric and the stored biometric information.

35. The method of claim 32, wherein the stored biometric information is one or more of a group consisting of: retinal information; fingerprint information; ocular information; DNA; veinal information; arterial information; voice information; and pulmonary information.

36. The system of claim 32, wherein the device is a portable device.

37. The system of claim 31, wherein said means for authenticating a user includes means for generating a second code.

38. The system of claim 37, further including means for granting a user access based on a comparison of the first code and the second code.

39. The method of claim 37, further including means for entering the first code with an input device.

40. The system of claim 38, wherein the means for entering the first code and for generating a second code are colocated.

41. The system of claim 38, wherein the means for granting a user access includes means for generating an access indicator for the input device.

42. The system of claim 41, wherein the means for granting a user access further includes means for transferring the access indicator to an access point where the user is located.

43. The system of claim 42, wherein the means for transferring the access indicator includes means for conveying the access indicator through a network, wherein the network is one or more of a group consisting of: wide area network; a local area network; a wireless network; a public switching telephone network; and the Internet.

44. The system of claim 39, further including means for transferring the first code from the input device to a processor for comparison of the first code and the second code.
